(19) United States
(12) Patent Application Publication
(10) Pub. No.: US 2009/0006481 A1
(43) Pub. Date: Jan. 1, 2009

(54) INFORMATION PROVIDING METHOD AND INFORMATION PROVIDING APPARATUS

(76) Inventors: Yi Hui, Beijing (CN); Zhong Su, Beijing (CN); Wei Sun, Beijing (CN); Kuo Zhang, GuoFeng Beijing (CN)

Correspondence Address: LAW OFFICE OF IDO TUCHMAN (YOR), ECM #72212, PO Box 4668, New York, NY, 10163-4668, US

(21) Appl. No.: 12/164,099

(22) Filed: Jun. 29, 2008

(30) Foreign Application Priority Data
Jun. 29, 2007 (CN) 200710126876.0

(51) Int. Cl. G06F 17/30

(52) U.S. Cl. 707/104.1; 707/E17.009

(57) ABSTRACT

A solution enabling a search engine to find content that is generated by executing client script. First, it is determined by a web application or plug-in whether a client that requests an initial web page comprising client script is a search engine or not. In the case that the client is a search engine, the client script is executed to generate corresponding content. Then, a new web page comprising the content is constructed, and a Uniform Resource Locator (URL) that points to the new web page is generated. Finally, the new web page is provided to the search engine together with the Uniform Resource Locator. In this manner, the search engine can get the content without executing the client script.

### CROSS-REFERENCE TO RELATED APPLICATIONS

This application claims priority under 35 U.S.C. §119 to Chinese Patent Application No. 200710126876.0 filed Jun. 29, 2007, the entire text of which is specifically incorporated by reference herein.

### BACKGROUND OF THE INVENTION

The present invention relates to the field of information technology, and more particularly, to an information providing method and an information providing apparatus which can be used for information search.

With the fashion of web 2.0, to bring better experience of web application and web pages to users, more and more web sites provide web pages containing client scripts to dynamically generate contents on clients, such as Microsoft Internet Explorer browsers.

However, it is difficult for a search engine to find and index these contents. For example, a server (web site) provides a web page written in HTML code as shown in FIG. 7.

For this web page, after a client, such as IE, Firefox and the like, accesses the server, it will display:

Hello, World

This is me

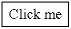

And when a user clicks the

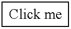

button on the client, it will display:

Hello, World

This is me

You click me

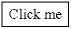

What needs to be noted is that when the user clicks the

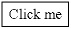

button on the client, the client can get the result, which is “You click me” here, without sending another request to the server.

However, for currently prevailing large-scale search engines (such as Google search engine, Baidu search engine, Yahoo search engine, etc.), when they access the server, they merely crawl and index “Hello, World” and the

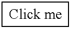

button. For other contents, such as “This is me” and “You click me,” search engines cannot find them and index them.

In other words, the search engine, more specifically the web crawler of the search engine, merely crawls the static content of a web page and discards the client script of the web page during crawling, unlike a normal client that will execute the client script in the aforesaid HTML code and generate “This is me” and “You click me.”

The main reasons why the search engine cannot execute the client script and generate corresponding content are listed below:

1. Efficiency. The web crawler of the search engine has to deal with billions of web pages every day, and by average, executing the client script in a web page is 10-100 times slower than simply parsing the web page. Therefore, the web crawler of the search engine discards execution of the client script out of consideration for the processing speed of the search engine.

2. Security. To allow execution of the client script in a web page in the search engine runtime environment will impose great security threat on the search engine.

3. Maintaining the client script context. To get the best efficiency, most of modern search engines comprise several stand alone parts which are used for handling different tasks, for example, one web crawler for retrieving a web page, one parser for parsing the web page, one or more analysis engines for analyzing the parsed web page. It is difficult to maintain and transfer the content generated by executing client script real time among these different parts.

4. Uncertainty of client script execution sequence. Usually, the client script in a web page is bound with the user interaction on the client side (for example, click a button, move the mouse, etc). For a search engine, it is impossible to predict the client script execution sequence. Additionally, executing the client script in all possible sequences is unacceptable to search engine for efficiency and security reasons.

Therefore, there is a pressing need to enable a search engine to find content generated by executing client script both from the perspective of a search engine and from the perspective of a web content provider (server).

### BRIEF SUMMARY OF THE INVENTION

It is an object of one embodiment of the present invention to enable a search engine to find corresponding content without executing client script.

According to a first aspect of the present invention, there is provided an information providing method comprising the steps of: determining a client that requests an initial web page comprising client script is a search engine; executing the client script to generate corresponding content; constructing a new web page comprising the content; generating a Uniform Resource Locator (URL) that points to the new web page; and providing the new web page to the search engine together with the Uniform Resource Locator.

According to a second aspect of the present invention, there is provided an information providing apparatus comprising: determining means for determining whether a client that requests an initial web page comprising client script is a search engine or not; executing means for executing the client script to generate corresponding content when the determining means determines that the client that requests an initial web page comprising client script is a search engine; constructing means for constructing a new web page comprising the content; generating means for generating a Uniform Resource Locator (URL) that points to the new web page; and providing means for providing the new web page to the search engine together with the Uniform Resource Locator.

According to a third aspect of the present invention, there is provided an information providing method comprising the steps of: determining that a client that requests information is not a search engine; determining that a Uniform Resource Locator of the request sources from a search engine; determining that the Uniform Resource Locator of the request is not a conventionally accessible Uniform Resource Locator; retrieving or constructing a corresponding web page according to the Uniform Resource Locator, wherein the web page comprises content that is generated by executing client script; and providing the web page to the client.

According to a fourth aspect of the present invention, there is provided an information providing apparatus comprising: first determining means for determining whether a client that requests information is a search engine or not; second determining means for determining whether a Uniform Resource Locator of the request sources from a search engine or not when the first determining means determines that the client is not a search engine; third determining means for determining whether the Uniform Resource Locator of the request is a conventionally accessible Uniform Resource Locator or not when the second determining means determines that the Uniform Resource Locator of the request sources from a search engine; retrieving means or constructing means for, when the third determining means determines that the Uniform Resource Locator of the request is not a conventionally accessible Uniform Resource Locator, retrieving or constructing a corresponding web page according to the Uniform Resource Locator, wherein the web page comprises content that is generated by executing client script; and providing means for providing the web page to the client.

With the present invention, the search engine can find corresponding content without executing the client script.

### BRIEF DESCRIPTION OF THE SEVERAL VIEWS OF THE DRAWINGS

Other objects and effects of the present invention will become more apparent and easy to understand from the following description, taken in conjunction with the accompanying drawings, wherein:

FIG. 1 shows an environment in which the embodiments of the present invention can be implemented;

FIG. 2 shows signal flow relations among entities comprised in the environment shown in FIG. 1;

FIG. 3 shows a schematic flowchart of an information providing method according to an embodiment of the present invention;

FIG. 4 shows a schematic flowchart of an information providing method according to another embodiment of the present invention;

FIG. 5 shows a schematic block diagram of an information providing apparatus according to an embodiment of the present invention;

FIG. 6 shows a schematic block diagram of an information providing apparatus according to another embodiment of the present invention; and

FIG. 7 shows a segment of HTML code.

Like reference numerals designate the same, similar, or corresponding features or functions throughout the drawings.

### DETAILED DESCRIPTION OF THE INVENTION

The basic idea of the present invention is described below: first, upon receipt of a connection request, a web application or a plug-in determines whether the client that requests an initial web page containing client script is a search engine or not, executes the client script to generate corresponding content in the case that the client is a search engine, constructs a new web page containing the content, generates a Uniform Resource Locator that points to the new web page, and provides the new page to the search engine together with the Uniform Resource Locator. In this manner, the search engine can get the aforesaid content without executing the client script.

After the search engine has analyzed and indexed the content, a user can search the content on the client via the search engine.

After the user has searched the content on the client via the search engine, he can click a corresponding Uniform Resource Locator in the web page of the search engine on the client to request the content from the server.

When it is determined that the request of the user via its client sources from the search engine, more specifically, sources from a search result list of the search engine and that what the user clicked is an unconventionally accessible Uniform Resource Locator, a web page containing the aforesaid content is retrieved or constructed according to the Uniform Resource Locator, and the web page is provided to the user's client.

In an embodiment of the present invention, the object of the present invention is achieved by providing a plug-in to a server. The advantage of this embodiment is that the object of the present invention will be achieved without modifying an existing web application on the server.

Of course, those skilled in the art can understand that the object of the present invention can be achieved by a web application itself on the server.

Such an embodiment that the object of the present invention is achieved by providing a plug-in to a server is involved in the following detailed description.

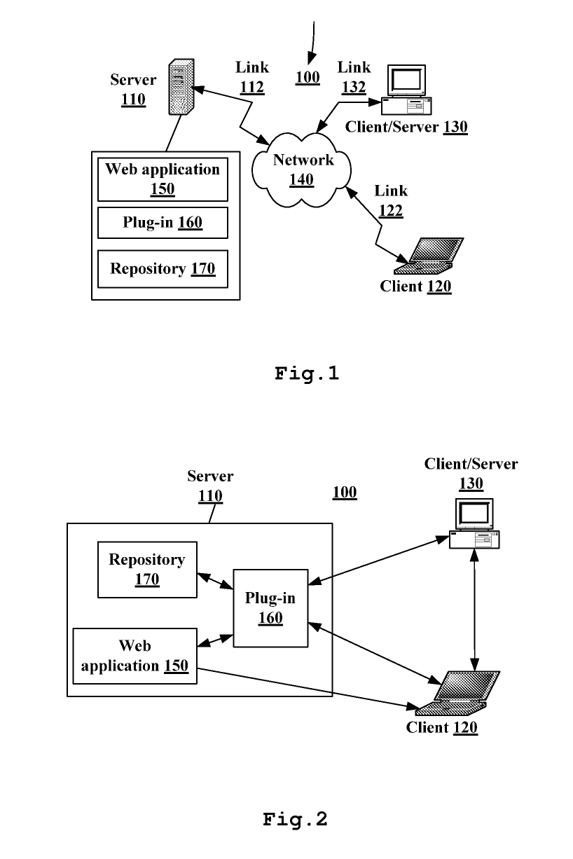

FIG. 1 shows an environment 100 in which the embodiments of the present invention can be implemented. As shown in FIG. 1, environment 100 comprises a server 110, a client 120, a client/server 130, and a network 140. Among them, server 110 is connected to network 140 via a link 112, client 120 is connected to network 140 via a link 122, and client/server 130 is connected to network 140 via a link 132. Links 112, 122 and 132 may be wired links, such as coaxial cables, optical fibers and the like, or wireless links, such as satellite links and the like. Likewise, network 140 may be a wireless network, a wired network, or a combination thereof. Furthermore, network 140 may be a local area network, a metropolitan area network, or a wide area network. For example, network 140 is the Internet.

On server 110 there are included a web application 150, a plug-in 160, and a repository 170.

Client 120 is a normal client.

Client/server 130 is a search engine that acts as a client when it accesses to server 110 to crawl a web page of web application 150 on server 110 and that acts as a server when client 120 accesses this search engine to search content.

Of course, those skilled in the art should understand that other clients and/or servers may be connected on the network 140. Moreover, in order to be distinguished from one another, these clients and servers each may have an identifier capable of uniquely identifying them, such as an IP address.

FIG. 2 shows in detail signal flow relations among entities comprised in the environment shown in FIG. 1.

Both client 120 and client/server 130 can access to server 110 to request a web page of web application 150.

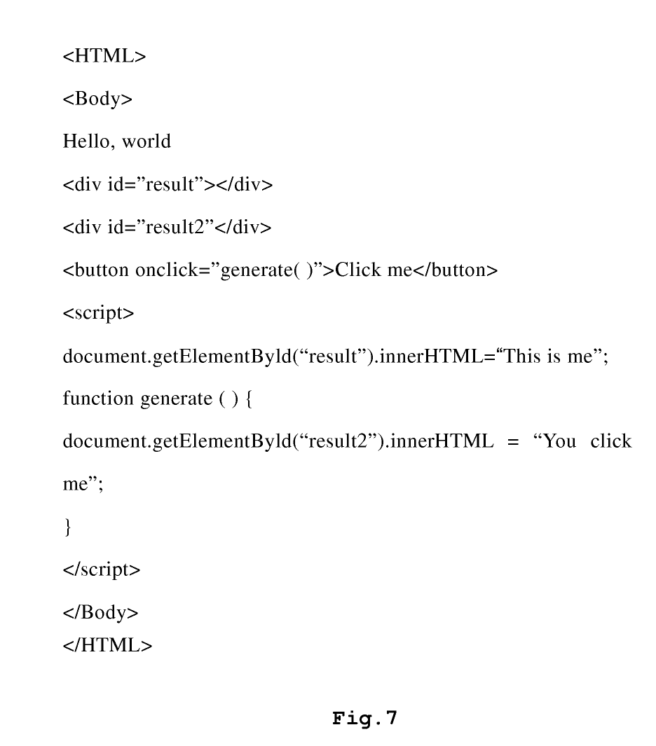

Here, assume that web application 150 provides a web page containing client script. When the client script is executed, corresponding content will be generated. For example, web application 150 provides the web page written in HTML code shown in FIG. 7.

In the present invention, the request of client 120 and the request of client/server 130 are first obtained by plug-in 160.

Then, plug-in 160 determines whether the request comes from a search engine or not. According to the standard, the web crawler of a search engine has to explicitly declare itself with an exclusive public name in the user agent section of a request header. For example, the name of Google web crawler is “Googlebot,” the name of Baidu web crawler is “Baiduspider”, and the name of Yahoo web crawler is “Yahoo! Slurp”. Therefore, with some matching rules, it is easy to determine whether the request comes from a normal client or comes from the web crawler of a search engine.

When plug-in 160 determines that the request comes from client 120, it redirects the request to web application 150, which sends a web page corresponding to the request to client 120 directly.

When plug-in 160 determines that the request comes from client/server 130, it retrieves a web page (initial web page) corresponding to the request from web application 150 and executes the client script contained in the web page to generate corresponding content. Then, plug-in 160 constructs a new web page (static web page) containing the generated content and generates a Uniform Resource Locator that points to the new web page containing the generated content. Afterwards, plug-in 160 provides the new web page containing the generated content to client/server 130 along with the Uniform Resource Locator, so that client/server 130 can get the content without executing the client script.

Content in the initial web page, which is not generated by executing the client script, namely static content, should also be included in the new web page.

In another embodiment of the present invention, plug-in 160 stores in repository 170 the constructed new web page containing the generated content and the Uniform Resource Locator that points to the new web page.

In an embodiment of the present invention, generation of the content does not need a parameter associated with the user interaction. Therefore, plug-in 160 generates the content without using the parameter associated with the user interaction.

In another embodiment of the present invention, generation of the content needs a parameter associated with the user interaction. Therefore, plug-in 160 generates the content by using the parameter associated with the user interaction.

Every action of the user may have a corresponding parameter.

The parameter is most apparent to administer/master of web application 150.

In a further embodiment of the present invention, the content comprises multiple parts, each of which is generated by using a single parameter or a sequential arrangement of multiple parameters. For example, envisage a scenario where the web page retrieved from server 110 and displayed on client 120 comprises multiple buttons. Every time the user clicks a button, the web page will display a different part of the content; or if the user clicks multiple buttons sequentially, the web page will display a different part of the content. For example, the web page will display one part of the content if the user clicks the first, second and third buttons in order, and the web page will display another part of the content if the user clicks the second, first and third buttons in order, and so on and so forth.

Therefore, plug-in 160 generates different parts of the content by using a single parameter or a sequential arrangement of multiple parameters.

In an embodiment of the present invention, plug-in 160 constructs a plurality of new web pages, each of which comprises one of the multiple parts of the content, generates a plurality of Uniform Resource Locators, each of which points to one of the plurality of constructed new web pages each comprising one of the multiple parts of the content, and provides the plurality of new web pages to client/server 130 together with the respective Uniform Resource Locators.

In another embodiment of the present invention, plug-in 160 constructs only a single new web page comprising the multiple parts of the content, generates a single Uniform Resource Locator that points to the constructed single new web comprising the multiple parts of the content, and provides the constructed single new web page comprising the multiple parts of the content to client/server 130 together with the single Uniform Resource Locator, so that client/server 130 can get the aforesaid content without executing the client script. In other words, in this embodiment, only after plug-in 160 has obtained all parts of the content, will it construct a single new web comprising all parts of the content.

In a further embodiment of the present invention, the content comprises two parts, a first part of which is generated without the need for parameter associated with the user interaction and a second part of which is generated with the need for parameter associated with the user interaction.

Therefore, plug-in 160 may construct two new web pages, one of which comprises the first part of the content and the other of which comprises the second part of the content, generates two Uniform Resource Locators, each of which points to one of the constructed two new web pages, and provides the two constructed new web pages to client/server 130 together with the two Uniform Resource Locators.

In another embodiment of the present invention, plug-in 160 constructs two new web pages, one of which comprises the first part of the content and the other of which comprises the first and second parts of the content, generates two Uniform Resource Locators, each of which points to one of the constructed two new web pages, and provides the two constructed new web pages to client/server 130 together with the two Uniform Resource Locators.

In other words, in this embodiment, plug-in 160 constructs a new web page, which merely comprises the first part of the content which is generated without the need for parameter associated with the user interaction, and a new web page, which comprises the first part of the content which is generated without the need for parameter associated with the user interaction and the second part of the content which is generated with the need for parameter associated with the user interaction.

Moreover, plug-in 160 may provide the constructed new web page comprising the first and second parts of the content to client/server 130 by placing the Uniform Resource Locator that points to the constructed new web page comprising the first and second parts of the content in the constructed new web page comprising the first part of the content.

For example, consider the situation where web application 150 on server 110 provides the web page written in HTML code shown in FIG. 7, wherein “This is me” is generated without the need for parameter associated with the user action whereas “You click me” is generated with the need for parameter associated with the user interaction.

In the embodiment mentioned previously, plug-in 160 will construct the following two new web pages:

First new web page

<HTML>

<Body>

Hello, world

<div id=“result”>This is me</div>

<div id=“result2”></div>

<a href=“index.html.action.html.button1.onclick”>Click me</a>

</Body>

</HTML>

Second new web page:

<HTML>

<Body>

Hello, world

<div id=“result”>This is me</div>

<div id=“result2”>You click me </div>

</Body>

</HTML>

It can be seen that the first new web page comprises the first part of the content “This is me” that is generated without the need for parameter associated with the user interaction, and the second new web page comprises both the first part of the content “This is me” that is generated without the need for parameter associated with the user interaction and the second part of the content “You click me” that is generated with the need for parameter associated with the user interaction.

Additionally, the Uniform Resource Locator (index.html.action.html.button1.onclick) that points to the second new web page is contained in the first new web page.

After client/server 130 has analyzed and indexed the content, the user can search the content on client 120 via client/server 130.

After the user has searched the content on client 120 via client/server 130, he can click a corresponding Uniform Resource Locator in the web page of the search engine on client 120, to make a request to server 110 (more specifically, to web application 150) for the content. Plug-in 160 can determine that the user's request sources from client/server 130, more specifically, from the search result list of the search engine, and can determine that what the user has clicked is an unconventionally accessible Uniform Resource Locator.

The Uniform Resource Locator that points to a new web page comprising the generated content and that is generated by plug-in 160 is an unconventionally accessible Uniform Resource Locator. If a user accesses server 110 by applying directly the Uniform Resource Locator on client 120 (other than by clicking the Uniform Resource Locator in the web page of the search engine on client 120), he will not get corresponding web page. On the contrary, a conventionally accessible Uniform Resource Locator is such a Uniform Resource Locator that when the user accesses server 110 by applying directly the Uniform Resource Locator, he will get a corresponding web page.

After that, plug-in 160 retrieves web page comprising the content from repository 170 according to the unconventionally accessible Uniform Resource Locator or constructs a web page comprising the content from web application 150 (in the case that the web page comprising the content is not stored in repository 170), and provides the web page to client 120.

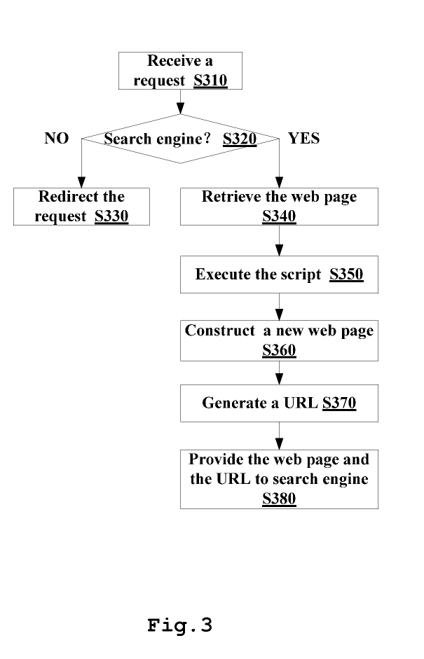

FIG. 3 shows a schematic flowchart of an information providing method according to an embodiment of the present invention.

Steps in this schematic flowchart are performed by, for example, plug-in 160.

First, a request for a web page comprising client script is received from a client (step S310).

Then, it is determined whether the client that requests a web page comprising the client script is a search engine or not (step S320).

When it is determined that the client that requests a web page comprising the client script is a normal client (the “No” branch of step S320), the flow goes to step S330, in which the request is redirected to a web application that provides a web page comprising the client script.

When it is determined that the client that requests a web page comprising the client script is a search engine the “Yes” branch of step S320), the flow goes to step S340.

In step S340, the web page (initial web page) is retrieved from the web application, and then the flow goes to step S350.

In step S350, the client script is executed to generate content, and then the flow goes to step S360.

In step S360, a new web page comprising the generated content is constructed, and then the flow goes to step S370.

In step S370, a Uniform Resource Locator that points to the constructed new web page comprising the generated content is generated, and then the flow goes to S380.

In step S380, the constructed new web page comprising the generated content is provided to the search engine together with the Uniform Resource Locator, so that the search engine can get the content without executing the client script.

In the above-described flowchart there may be further comprised the steps of storing in a repository the constructed new web page comprising the generated content and of storing in the repository the Uniform Resource Locator that points to the new web page.

As described previously, the content is generated either without or with the need for parameter associated with the user interaction.

Further, the content comprises multiple parts, each of which is generated by using a single parameter or a sequential arrangement of multiple parameters. At this point, in step S360 to step S380, a plurality of new web pages are constructed, each of which comprising one of the multiple parts of the content; and a plurality of Uniform Resource Locators are generated, each of which points to one of the plurality of constructed new web pages each comprising one of the multiple parts of the content, and the plurality of new web pages are provided to the search engine together with the plurality of Uniform Resource Locators, so that the search engine can get the content without executing the client script.

As described previously, in step S360 to step S380, only a single new web page comprising the multiple parts of the content is constructed, a single Uniform Resource Locator that points to the constructed single new web comprising the multiple parts of the content is generated, and the constructed single new web page comprising the multiple parts of the content is provided to the search engine together with the single Uniform Resource Locator, so that the search engine can get the aforesaid content without executing the client script. In other words, in step S360, only after all parts of the content have been obtained, will a single new web comprising all parts of the content be constructed.

As described previously, the content comprises two parts, a first part of which is generated without the need for parameter associated with the user interaction and a second part of which is generated with the need for parameter associated with the user interaction.

Therefore, in step S360 to step S380, two new web pages are constructed, one of which comprises the first part of the content and the other of which comprises the second part of the content, two Uniform Resource Locators, each of which points to one of the constructed two new web pages are generated, and the two constructed new web pages are provided to the search engine together with the two Uniform Resource Locators, so that the search engine can get the content without executing the client script.

As described previously, in step S360 to step S380, two new web pages are constructed, one of which comprises the first part of the content and the other of which comprises the first and second parts of the content, two Uniform Resource Locators, each of which points to one of the constructed two new web pages are generated, and the two constructed new web pages are provided to the search engine together with the two Uniform Resource Locators, so that the search engine can get the content without executing the client script.

In other words, in constructing step S360, a new web page which merely comprises the first part of the content which is generated without the need for parameter associated with the user interaction and a new web page which comprises the first part of the content which is generated without the need for parameter associated with the user interaction and the second part of the content which is generated with the need for parameter associated with the user interaction are constructed.

Moreover, the constructed new web page comprising the first and second parts of the content may be provided to the search engine by placing the Uniform Resource Locator that points to the constructed new web page comprising the first and second parts of the content in the constructed new web page comprising the first part of the content.

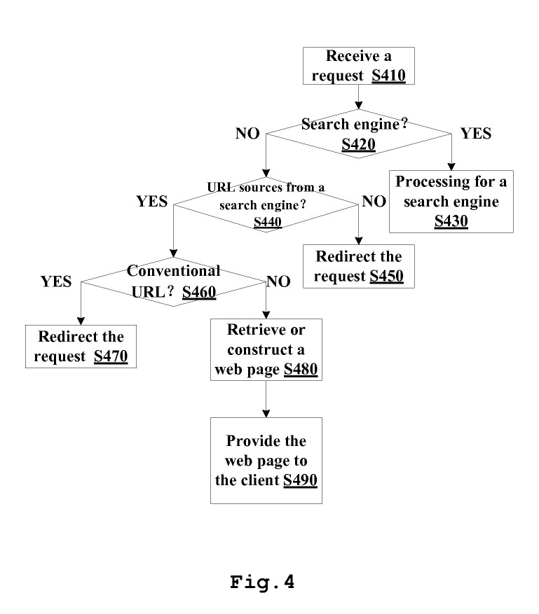

FIG. 4 shows a schematic flowchart of an information providing method according to another embodiment of the present invention.

Steps in this schematic flowchart are performed by, for example, plug-in 160.

First, a request is received from a client (step S410), and then the flow goes to step S420.

In step S420, it is determined whether the client is a search engine or not.

When it is determined that the client is a search engine (the “Yes” branch of step S420), the flow goes to step S430 to start step S340 to step S380 as described with reference to FIG. 3.

When it is determined that the client is not a search engine (the “No” branch of step S420), the flow goes to step S440.

In step S440, it is determined whether the Uniform Resource Locator of the request sources from a search engine or not.

When it is determined that the Uniform Resource Locator of the request does not source from a search engine (the “No” branch of step S440), the flow goes to step S450 in which the request is redirected to and handled by a web application.

When it is determined that the Uniform Resource Locator of the request sources from a search engine, the flow goes to step S460.

In step S460, it is determined whether the Uniform Resource Locator of the request is a conventionally accessible Uniform Resource Locator or not.

When it is determined that the Uniform Resource Locator of the request is a conventionally accessible Uniform Resource Locator, the flow goes to step S470. In step S470, the request is redirected to a web application, and the web application provides to the client a web page corresponding to the Uniform Resource Locator.

When it is determined that the Uniform Resource Locator of the request is not a conventionally accessible Uniform Resource Locator, the flow goes to step S480. In step 480, a corresponding web page is retrieved or constructed according to the Uniform Resource Locator, wherein the web page comprises content that is generated by executing client script.

In the case that the new web page and the Uniform Resource Locator that points to the new web page are stored in repository 170, a corresponding web page is retrieved from repository 170 according to the Uniform Resource Locator of the request.

In the case that the new web page and the Uniform Resource Locator that points to the new web page are not stored in repository 170, a corresponding web page is constructed according to the Uniform Resource Locator of the request.

Then, the flow goes to step S490 in which the web page is provided to the client.

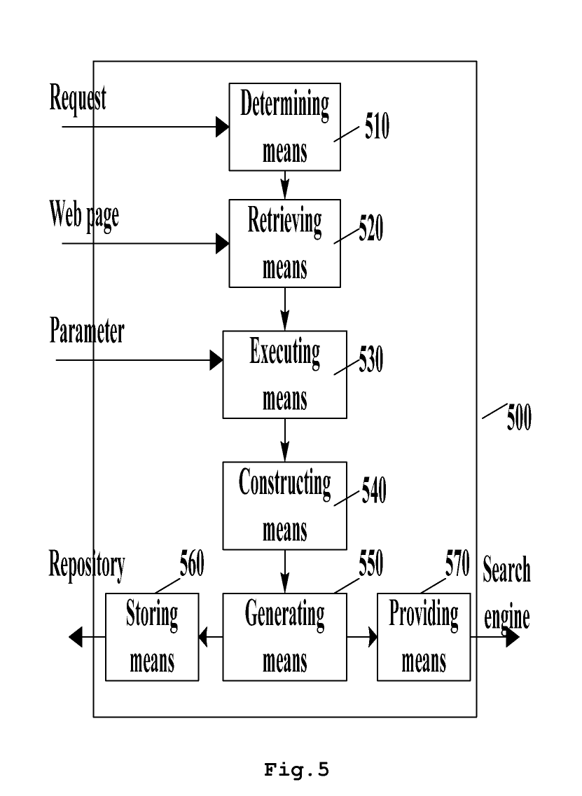

FIG. 5 shows a schematic block diagram of an information providing apparatus 500 according to an embodiment of the present invention.

Information providing apparatus 500 is used to enable a search engine to find content that is generated by executing client script.

Information providing apparatus 500 is, for example, a plug-in installed on a server.

Information providing apparatus 500 comprises: determining means 510 for determining whether a client that requests a web page comprising the client script is a search engine or not; retrieving means 520 for retrieving the web page (initial web page) when determining means 510 determines that the client that requests a web page comprising the client script is a search engine; executing means 530 for executing the client script to generate content; constructing means 540 for constructing a new web page comprising the generated content; generating means 550 for generating a Uniform Resource Locator that points to the constructed new web page comprising the generated content; and providing means 570 for providing the constructed new web page comprising the generated content to the search engine together with the Uniform Resource Locator, so that the search engine can get the content without executing the client script. Information providing apparatus 500 may further comprising storing means 560 for storing in a repository the constructed new web page comprising the generated content and the generated Uniform Resource Locator that points to the constructed new web page comprising the generated content.

As described previously, the content is generated either without or with the need for parameter associated with the user interaction.

Further, the content comprises multiple parts, each of which is generated by using a single parameter or a sequential arrangement of multiple parameters. At this point, constructing means 540 constructs a plurality of new web pages, each of which comprises one of the multiple parts of the content, and generating means 550 generates a plurality of Uniform Resource Locators, each of which points to one of the plurality of constructed new web pages each comprising one of the multiple parts of the content, and providing means 570 provides the plurality of new web pages to the search engine together with the plurality of Uniform Resource Locators, so that the search engine can get the content without executing the client script.

As described previously, constructing means 540 constructs only a single new web page comprising the multiple parts of the content, and generating means 550 generates a single Uniform Resource Locator that points to the constructed single new web comprising the multiple parts of the content, and providing means 570 provides the constructed single new web page comprising the multiple parts of the content to the search engine together with the single Uniform Resource Locator, so that the search engine can get the aforesaid content without executing the client script. In other words, only after constructing means 540 has obtained all parts of the content, will it construct a single new web comprising all parts of the content.

As described previously, the content comprises two parts, a first part of which is generated without the need for parameter associated with the user interaction and a second part of which is generated with the need for parameter associated with the user interaction.

Therefore, constructing means 540 constructs two new web pages, one of which comprises the first part of the content and the other of which comprises the second part of the content, and generating means 550 generates two Uniform Resource Locators, each of which points to one of the constructed two new web pages, and providing means 570 provides the two constructed new web pages to the search engine together with the two Uniform Resource Locators, so that the search engine can get the content without executing the client script.

As described previously, constructing means 540 constructs two new web pages, one of which comprises the first part of the content and the other of which comprises the first and second parts of the content, and generating means 550 generates two Uniform Resource Locators, each of which points to one of the constructed two new web pages, and providing means 570 provides the two constructed new web pages to the search engine together with the two Uniform Resource Locators, so that the search engine can get the content without executing the client script. In other words, constructing means 540 constructs a new web page which merely comprises the first part of the content which is generated without the need for parameter associated with the user interaction and a new web page which comprises the first part of the content which is generated without the need for parameter associated with the user interaction and the second part of the content which is generated with the need for parameter associated with the user interaction.

Moreover, the constructed new web page comprising the first and second parts of the content may be provided to the search engine by placing the Uniform Resource Locator that points to the constructed new web page comprising the first and second parts of the content in the constructed new web page comprising the first part of the content.

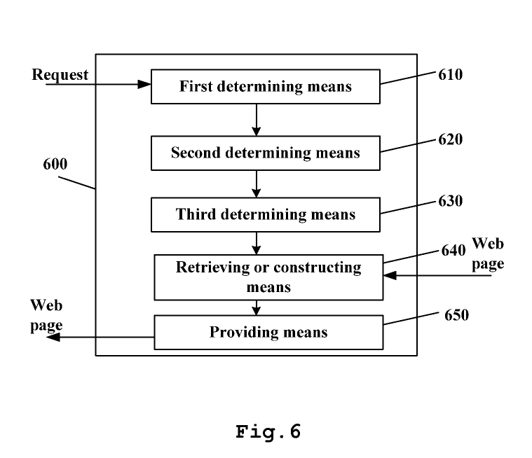

FIG. 6 shows a schematic block diagram of an information providing apparatus 600 according to another embodiment of the present invention.

Information providing apparatus 600 is, for example, a plug-in installed on a server.

Information providing apparatus 600 is used for response to a request from a client.

Apparatus 600 comprises: first determining means 610 for determining whether the client is a search engine or not; second determining means 620 for determining whether the Uniform Resource Locator of the request sources from a search engine or not when first determining means 610 determines that the client is not a search engine; third determining means 630 for determining whether the Uniform Resource Locator of the request is a conventionally accessible Uniform Resource Locator or not when second determining means 620 determines that the Uniform Resource Locator of the request sources from a search engine; retrieving means or constructing means 640 for, when third determining means 630 determines that the Uniform Resource Locator of the request is not a conventionally accessible Uniform Resource Locator, retrieving or constructing a corresponding web page according to the Uniform Resource Locator, wherein the web page comprises content that is generated by executing client script; and providing means 650 for providing the web page to the client.

It should be noted that in order to facilitate easier understanding of the present invention, the foregoing description omits more detailed technical details that are well known to those skilled in the art and might be indispensable to the implementation of the present invention.

The specification of the present invention has been presented for purposes of illustration and description, and is not intended to be exhaustive or limit the invention in the form disclosed. Many modifications and variations will be apparent to those of ordinary skill in the art.

For example, in the case that the object of the present invention is achieved by a web application itself, i.e., the functions of plug-in 160 are integrated to web application 150, step S330 of redirecting the request in FIG. 3 can be the step of handling the request directly, and step S340 of retrieving the web page can be omitted; step S450 and step S470 of redirecting the request in FIG. 4 can be steps of handling the request directly; and retrieving means 520 in the information providing apparatus shown in FIG. 5 can be omitted.

For another example, plug-in 160 is not necessarily installed on server 110. On the contrary, plug-in 160 can be installed on any device (such as a router, a gateway and the like) between server 110 and search engine 130. In other words, it is acceptable provided that plug-in 160 is not located at search engine 130.

When plug-in 160 is on a router, the steps it performs are identical to those when it is on server 110. More specifically, in the case that plug-in 160 is on a router, upon receipt of a connection request from a client, plug-in 160 determines whether the client that requests an initial web page comprising client script is a search engine or not. In the case that the client is a search engine, plug-in 160 retrieves the initial web page from server 110 and executes the client script in the initial web page to generate corresponding content. Then, plug-in 160 constructs a new web page comprising the content, generates a Uniform Resource Locator that points to the new web page, and provides the new web page to the search engine together with the Uniform Resource Locator.

In the case that the client is not a search engine, plug-in 160 forwards the request to server 110.

Therefore, the embodiments were chosen and described in order to best explain the principles of the invention, the practical application thereof, and to enable others of ordinary skill in the art to understand that all modifications and alterations made without departing from the spirit of the present invention fall into the protection scope of the present invention as defined in the appended claims.

That which is claimed is:

1. An information providing method, comprising the steps of:
determining a client that requests an initial web page comprising client script is a search engine;
executing the client script to generate corresponding content;
constructing a new web page comprising the content;
generating a Uniform Resource Locator (URL) pointing to the new web page; and
providing the new web page to the search engine together with the Uniform Resource Locator.

2. The method according to claim 1, further comprising the step of:
storing the new web page and the Uniform Resource Locator.

3. The method according to claim 1, before the step of executing the client script to generate corresponding content, further comprising the step of:
retrieving the initial web page.

4. The method according to claim 1, wherein the content is generated without the need for parameter associated with the user interaction.

5. The method according to claim 1, wherein the content is generated with the need for parameter associated with the user interaction.

6. The method according to claim 5, wherein the content comprise multiple parts, each of which is generated by using a single parameter or a sequential arrangement of multiple parameters, and in the constructing step, a plurality of new web pages are constructed, each of which comprises one of the multiple parts, and in the generating step, a plurality of Uniform Resource Locators are generated, each of which points to one of the plurality of new web pages, and in the providing step, the plurality of new web pages are provided to the search engine together with the plurality of Uniform Resource Locators.

7. The method according to claim 1, wherein the content comprises two parts, a first part of which is generated without the need for parameter associated with the user interaction and a second part of which is generated with the need for parameter associated with the user interaction, and
in the constructing step, two new web pages are constructed, one of which comprises the first part and the other of which comprises the first and second parts, and in the generating step, two Uniform Resource Locators are generated, each of which points to one of the two new web pages, and in the providing step, the two new web pages are provided to the search engine together with the two Uniform Resource Locators.

8. The method according to claim 1, wherein the new web page further comprises content in the initial web page which is not generated by executing the client script.

9. An information providing apparatus, comprising:
determining means for determining whether a client that requests an initial web page comprising client script is a search engine or not;
executing means for executing the client script to generate corresponding content when the determining means determines that the client that requests an initial web page comprising client script is a search engine;
constructing means for constructing a new web page comprising the content;
generating means for generating a Uniform Resource Locator that points to the new web page; and
providing means for providing the new web page to the search engine together with the Uniform Resource Locator.

10. The apparatus according to claim 9, further comprising:
storing means for storing the new web page and the Uniform Resource Locator in a repository.

11. The apparatus according to claim 9, further comprising:
retrieving means for, when the determining means determines that the client that requests an initial web page comprising client script is a search engine, retrieving the initial web page and providing the initial web page to the executing means.

12. The apparatus according to claim 9, wherein the content is generated without the need for parameter associated with the user interaction.

13. The apparatus according to claim 9, wherein the content is generated with the need for parameter associated with the user interaction.

14. The apparatus according to claim 13, wherein the content comprises multiple parts, each of which is generated by using a single parameter or a sequential arrangement of multiple parameters, and the constructing means constructs a plurality of new web pages, each of which comprises one of the multiple parts, and the generating means generates a plurality of Uniform Resource Locators, each of which points to one of the plurality of new web pages, and the providing means provides the plurality of new web pages to the search engine together with the plurality of Uniform Resource Locators.

15. The apparatus according to claim 9, wherein the content comprises two parts, a first part of which is generated without the need for parameter associated with the user interaction and a second part of which is generated with the need for parameter associated with the user interaction, and
the constructing means constructs two new web pages, one of which comprises the first part and the other of which comprises the first and second parts, and the generating means generates two Uniform Resource Locators, each of which points to one of the two new web pages, and the providing means provides the two new web pages to the search engine together with the two Uniform Resource Locators.

16. The apparatus according to claim 9, wherein the new web page further comprises static content in the initial web page.

17. An information providing method, comprising the steps of:
determining that a client that requests information is not a search engine;
determining that a Uniform Resource Locator of the request sources from a search engine;
determining that the Uniform Resource Locator of the request is not a conventionally accessible Uniform Resource Locator;
retrieving or constructing a corresponding web page according to the Uniform Resource Locator, wherein the web page comprises content that is generated by executing client script; and
providing the web page to the client.

18. An information providing apparatus, comprising:
first determining means for determining whether a client that requests information is a search engine or not;
second determining means for determining whether a Uniform Resource Locator of the request sources from a search engine or not when the first determining means determines that the client is not a search engine;
third determining means for determining whether the Uniform Resource Locator of the request is a conventionally accessible Uniform Resource Locator or not when the second determining means determines that the Uniform Resource Locator of the request sources from a search engine;
retrieving means or constructing means for, when the third determining means determines that the Uniform Resource Locator of the request is not a conventionally accessible Uniform Resource Locator, retrieving or constructing a corresponding web page according to the Uniform Resource Locator, wherein the web page comprises content that is generated by executing client script; and
providing means for providing the web page to the client.
